(19) United States
(12) Patent Application Publication
(10) Pub. No.: US 2018/0348080 A1
(43) Pub. Date: Dec. 6, 2018

(54) DEVICE, METHOD, AND RECORDING MEDIUM

(71) Applicant: NEC Corporation, Minato-ku, Tokyo (JP)

(72) Inventors: Hirofumi INOUE, Tokyo (JP); Takahiro KUMURA, Tokyo (JP); Soichiro TAKATA, Tokyo (JP)

(73) Assignee: NEC Corporation, Minato-ku, Tokyo (JP)

(21) Appl. No.: 15/779,907

(22) PCT Filed: Dec. 1, 2016
(86) PCT No.: PCT/JP2016/085756

§ 371 Date: May 30, 2018

(30) Foreign Application Priority Data
Dec. 3, 2015 (JP) 2015-236985

(51) Int. Cl. G01M 3/24

(52) U.S. Cl. CPC G01M 3/243

(57) ABSTRACT

Provided is a device that may accurately predict a deterioration tendency of a pipe. The device includes a plurality of detection units 10, a cross-correlation function calculation unit 22, a deterioration level calculation unit 24, and a deterioration prediction unit 25. The plurality of detection units 10 detect undulations at least two locations in a pipe in which a fluid flows. The cross-correlation function calculation unit 22 calculates a cross-correlation function of the pipe, based on the undulations at the at least two locations in the pipe detected by the plurality of detection units 10. The deterioration level calculation unit 24 calculates a deterioration level of the pipe, based on a shape of the cross-correlation function of the pipe. The deterioration prediction unit 25 predicts a deterioration tendency of the pipe, based on a temporal change of the deterioration level.

This application is a National Stage Entry of PCT/JP2016/085756 filed on Dec. 1, 2016, which claims priority from Japanese Patent Application 2015-236985 filed on Dec. 3, 2015, the contents of all of which are incorporated herein by reference, in their entirety.

### TECHNICAL FIELD

The present invention relates to a device, a method, and a recording medium.

### BACKGROUND ART

Many piping networks for transporting water, petroleum, gas, and the like are used beyond their useful years, and have problems of fluid leakage and piping rupture accident due to deterioration. In order to solve these problems, it is necessary to repair a pipe at an appropriate time. A pipe is generally repaired based on the number of years for which the pipe has been laid, but is ideally repaired according to a plan depending on a deterioration level of the pipe.

PTL 1 describes a method of forming a repair plan of a pipe, based on a leakage amount estimated from a pressure wave generated by water leakage.

### CITATION LIST

### Patent Literature

[PTL 1] Japanese Laid-open Patent Publication No. H9 (1997)-23483

[PTL 2] Japanese Laid-open Patent Publication No. H10 (1998)-176970

[PTL 3] Japanese Laid-open Patent Publication No. H10 up (1998)-274642

### SUMMARY OF INVENTION

### Technical Problem

In the method described in PTL 1, a leakage amount is estimated assuming that a proportionality relation is satisfied between a pressure wave generated by water leakage and a leakage amount. Therefore, when the assumption is not satisfied, it is not necessarily possible to accurately obtain a leakage amount from a pressure wave, and an effective pipe repair plan cannot be formed.

Thus, an object of the present invention is to provide a device and a method which enable a deterioration tendency of a pipe to be accurately predicted.

### Solution to Problem

In order to attain the above object, a first device according to the present invention includes a plurality of detectors and at least one processor. The processor implements a cross-correlation function calculation unit, a deterioration level calculation unit, and a deterioration prediction unit. The up plurality of detectors detect undulations at least two locations in a pipe in which fluid flows. The cross-correlation function calculation unit calculates a cross-correlation function of the pipe, based on undulations at least two locations in the pipe which are detected by the plurality of detectors. The deterioration level calculation unit calculates a deterioration level of the pipe, based on a shape of a cross-correlation function of the pipe. The deterioration prediction unit predicts a deterioration tendency of the pipe, based on a temporal change of the deterioration level.

A first method executed by at least one processor according to the present invention includes: detecting, by use of a plurality of detectors disposed in a pipe in which fluid flows, undulations at least two locations in the pipe; calculating a cross-correlation function of the pipe, based on undulations at least two locations in the pipe which are detected by the plurality of detectors; calculating a deterioration level of the pipe, based on a shape of the cross-correlation function of the pipe, and predicting a deterioration tendency of the pipe, based on a temporal change of the deterioration level.

A second device according to the present invention includes a plurality of detectors and at least one processor. The processor implements a deterioration level calculation unit, and a pipe repair order determination unit. The plurality of detectors detect undulations at least two locations in each of a plurality of linked pipes in which fluid flows. The deterioration level calculation unit calculates a deterioration velocity of the pipe which is a temporal change of a deterioration level of the pipe, based on undulations at least two locations in the pipe which are detected by the plurality of detectors. The pipe repair order determination unit determines a repair order of the plurality of pipes, based on a deterioration velocity of each of the pipes.

A second method executed by at least one processor according to the present invention includes: detecting, by use of a plurality of detectors disposed in each of a plurality of linked pipes in which fluid flows, undulations at least two locations in the pipe; calculating a deterioration velocity of the pipe which is a temporal change of a deterioration level of the pipe, based on undulations at least two locations in the pipe which are detected by the plurality of detectors; and determining a repair order of the plurality of pipes, based on a deterioration velocity of each of the pipes.

A third device according to the present invention includes at least one processor. The processor implements a pipe information acquisition unit, a repair order list generation unit, and a list output unit. The pipe information acquisition unit acquires information about each of a plurality of linked pipes. The repair order list generation unit determines a repair order of the plurality of pipes, and generates a list of a pipe repair order, based on information about each of the pipes. The list output unit outputs the list of the pipe repair order.

A third method executed by at least one processor according to the present invention includes: acquiring information about each of a plurality of linked pipes; determining a repair order of the plurality of pipes, and generating a list of a pipe repair order, based on information about each of the pipes; and outputting the list of the pipe repair order.

### Advantageous Effects of Invention

According to the device and the method of the present invention, a deterioration tendency of a pipe can be accurately predicted.

### BRIEF DESCRIPTION OF DRAWINGS

FIG. 1 is a schematic diagram illustrating one example of a configuration of a device according to a first example embodiment.

FIG. 2 is a schematic block diagram illustrating one example of a configuration of a detection unit in the device according to the first example embodiment.

FIG. 3 is a schematic block diagram illustrating one example of a configuration of a processing unit in the device according to the first example embodiment.

FIG. 4 is a flowchart illustrating one example of a method according to the first example embodiment.

FIG. 5 is a graph exemplifying a cross-correlation function in each example embodiment of the present invention.

FIG. 6 is a graph exemplifying a deterioration level in each example embodiment of the present invention.

FIG. 7 is a schematic block diagram illustrating one example of a configuration of a processing unit in a device according to a second example embodiment.

FIG. 8 is a diagram illustrating a plurality of propagation modes in each example embodiment of the present invention.

FIG. 9 is a flowchart illustrating one example of a method according to the second example embodiment.

FIG. 10 is a graph illustrating another example of a cross-correlation function in each example embodiment of the present invention.

FIG. 11 is a flowchart illustrating one example of a method according to a third example embodiment.

FIG. 12 is a graph illustrating still another example of a cross-correlation function in each example embodiment of the present invention.

FIG. 13 is a diagram illustrating an output example in a fifth example embodiment.

FIG. 14 is a schematic block diagram illustrating one example of a hardware configuration of the device according to each example embodiment of the present invention.

### DESCRIPTION OF EMBODIMENTS

In each example embodiment below, “repair” of a pipe may be, for example, repair of a pipe being used, or replacement of a pipe with a new pipe.

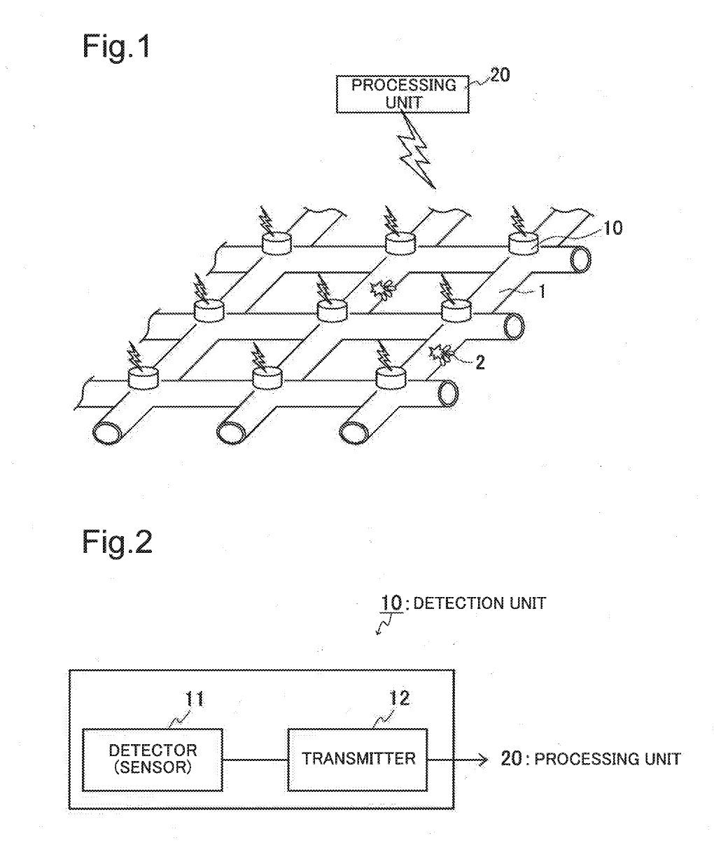

Hereinafter, a device, a method, a program, and a recording medium according to the present invention will be described in detail with reference to the drawings. However, the present invention is not limited to the description below. Note that in FIGS. 1 to 14 below, the same reference marks are given to the same parts, and description thereof is omitted in some cases. Further, in the drawings, a structure of each part is properly illustrated in a simplified way for convenience of explanation in some cases, and a dimension, a ratio, and the like of each part are different from real ones, and schematically illustrated in some cases.

### First Example Embodiment

The present example embodiment is one example of a first device and a first method according to the present invention. A configuration of the device in the present example is illustrated in a schematic diagram of FIG. 1. As illustrated, the device in the present example includes a plurality of detection units 10, and a processing unit 20. Each detection unit (hereinafter referred to as “detection unit 10”) of the plurality of detection units 10 can perform wireless communication or wire communication with the processing unit 20.

The detection unit 10 is disposed in such a way as to be able to detect, via a pipe 1, an undulation (e.g., a pressure wave, vibration, or the like) propagating through the pipe 1 or fluid (e.g., liquid, gas, or the like) flowing in the pipe 1. For example, the detection unit 10 may be disposed on an outer wall surface or an inner wall surface of the pipe 1, or disposed on an outer surface of or inside an accessory (not illustrated) such as a flange (not illustrated) disposed in the pipe 1, a valve plug or the like. In the example of FIG. 1, the detection unit 10 is disposed on a wall of the pipe 1. For example, a method of disposing the detection unit 10 in the pipe 1 or an accessory or the like of the pipe 1 includes a method using a magnet, an exclusive jig, an adhesive agent, or the like. Note that the pipe 1 may be buried in ground, disposed in an attic or a basement of a building, or buried in a wall, a pillar, or the like of a building, for example.

Hereinafter, the present example embodiment assumes a case where N pipes are targeted, and N sets of (2N) detection units are disposed at both ends of these pipes. In an example used in the description below, detection units 10a1, 10a2, 10b1, 10b2, . . . , 10n1, and 10n2 are disposed at both ends of pipes 1a, 1b, . . . , and 1n. However, in the first device and the first method according to the present example embodiment, the number of pipes and the number of detection units are not limited to the example described above. For example, one pipe may be provided, and two detection units may be provided.

FIG. 2 is a schematic block diagram illustrating one example of a configuration of the detection unit 10. As illustrated, the detection unit 10 in the present example includes a detector (sensor) 11 and a transmitter 12. In the detection unit 10, the transmitter 12 is an optional component and does not need to be included, but is preferably included.

The sensor 11 detects an undulation of the pipe 1. Specifically, the sensor 11 detects an undulation which is generated and propagates due to the pipe 1 or a state of fluid flowing in the pipe 1. The undulation is detected by the sensor 11 via the pipe 1 or an accessory or the like disposed in the pipe 1. The sensor 11 may be, for example, always provided at a mounting location and always detect an undulation, or may be disposed for a predetermined period of time and intermittently detect an undulation. For example, as the sensor 11, it is possible to use a sensor capable of detecting an undulation of a solid, specifically, a piezoelectric acceleration sensor, an electrostatic acceleration sensor, a capacitance acceleration sensor, an optical acceleration sensor, an optical velocity sensor, a dynamic strain sensor, and the like.

The transmitter 12 transmits the undulation of the pipe 1 detected by the sensor 11 to the processing unit 20. A means conventionally known in public may be used as the transmitter 12.

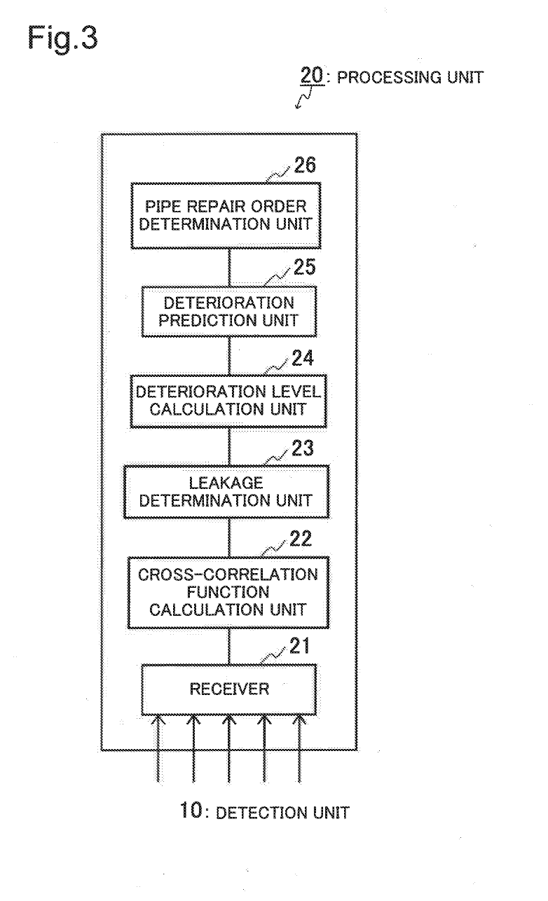

FIG. 3 is a schematic block diagram illustrating one example of a configuration of the processing unit 20. As illustrated, the processing unit 20 in the present example includes a receiver 21, a cross-correlation function calculation unit 22, a leakage determination unit 23, a deterioration level calculation unit 24, a deterioration prediction unit 25, and a pipe repair order determination unit 26. In the processing unit 20, the receiver 21, the leakage determination unit 23, and the pipe repair order determination unit 26 are optional components and do not need to be included, but are preferably included.

The receiver 21 receives the undulation of the pipe 1 transmitted from the transmitter 12 of the detection unit 10. A means conventionally known in public may be used as the receiver 21.

The cross-correlation function calculation unit 22 calculates N cross-correlation functions, based on N sets (2N pieces) of undulations detected by the detection units 10a1, 10a2, 10b1, 10b2, 10n1, and 10n2 disposed in the pipes 1a, 1b, . . . , and 1n.

The undulation propagating in the pipe 1 is represented by

p(x)=P₀(ω)e^{-ikx} [Expression 1]

Here, p (x) is amplitude (Pa) of a wave at a place a distance x (m) away from a leakage point, P0 (ω) is amplitude (Pa) of a wave at the leakage point, ω is an angular frequency (rad), and k is the number of waves (m⁻¹). k is represented by

$$k = \frac{ω}{{{C}_{f} ( 1 + \frac{2 Ba}{Eh} )}^{- \frac{1}{2}}} - i \frac{1}{{C}_{f}} \frac{\frac{η Ba}{Eh}}{{( 1 + ( \frac{2 Ba}{Eh} ) )}^{\frac{1}{2}}} \qquad [ Expression 2 ]$$

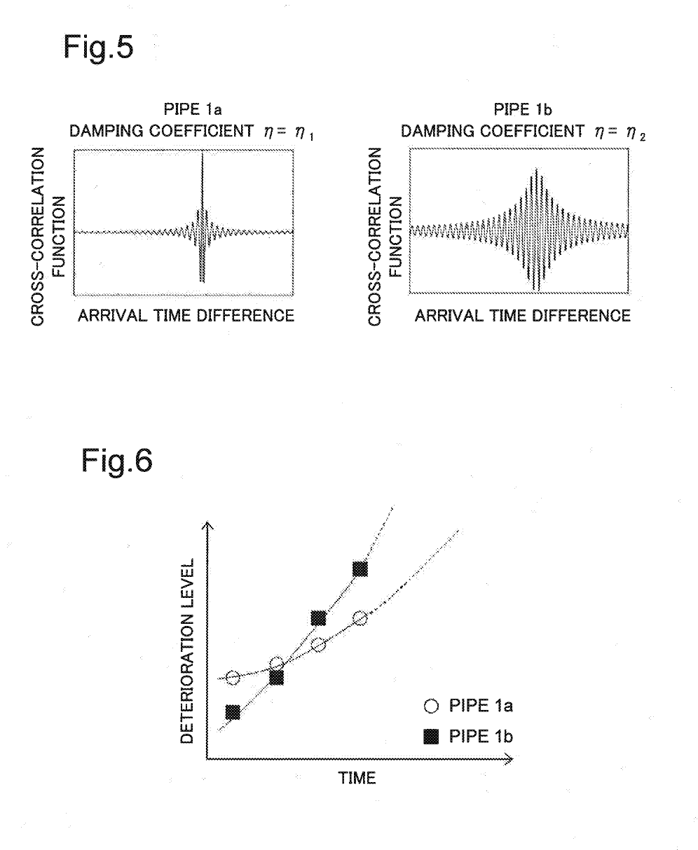

Here, cf is an acoustic velocity (m/s) of fluid, B is a bulk modulus (Pa) of fluid, a is a radius of the pipe, E is a longitudinal modulus (Pa) of the pipe, h is thickness (m) of the pipe, and η is a damping coefficient of the pipe. Note that the damping coefficient is a dimensionless value indicating a degree of duration of resonance generated when an object is vibrated, for example. Assuming that a frequency band of an undulation generated by leakage is flat, a shape of a cross-correlation function of the undulation detected by a set of detection units is determined by a propagation characteristic of a pipe. For example, a cross-correlation function when the damping coefficient η of the pipe differs is as illustrated in FIG. 5. In FIG. 5, a horizontal axis indicates an arrival time difference, and a vertical axis indicates a cross-correlation function. Note that a frequency band of an undulation being flat means that power spectrum density is constant with respect to frequency. In other words, the present example embodiment assumes that an undulation generated by leakage is white noise which does not have frequency dependency.

The leakage determination unit 23 determines whether leakage is present in the pipes 1a, 1b, . . . , and 1n, based on the N sets of (2N pieces) cross-correlation functions. Specifically, the leakage determination unit 23 determines whether a leakage hole 2 is formed in the pipe 1 by determining whether a maximum value of the cross-correlation function is beyond a threshold at a normal time, for example.

The deterioration level calculation unit 24 calculates deterioration levels of the pipes 1a, 1b, . . . , and 1n, based on shapes of the N sets of (2N pieces) cross-correlation functions. For example, a difference between a value of the cross-correlation function and a value thereof at a normal time is used as a deterioration level. Specifically, a value of a ratio of a value in which a damping coefficient of a normal pipe is subtracted from a measured damping coefficient to a value in which the damping coefficient of the normal pipe is subtracted from an average value of damping coefficients of a deteriorated pipe is used as a deterioration level. Based on a shape of the cross-correlation function of a pipe determined to have leakage by the leakage determination unit 23, the deterioration level calculation unit 24 may calculate a deterioration level of the pipe.

The deterioration prediction unit 25 predicts a deterioration tendency of the pipe, based on a temporal change of the deterioration level. Specifically, as illustrated in FIG. 6, it is possible to predict a deterioration tendency of the pipe by a polynomial regression curve in a graph in which a deterioration level is plotted on an x-y plane with a deterioration level on a vertical axis (y-axis) and time on a horizontal axis (x-axis), for example.

The pipe repair order determination unit 26 determines a repair order of the pipes 1a, 1b, . . . , and 1n, based on the deterioration tendency predicted by the deterioration prediction unit 25. Specifically, a pipe having a higher deterioration velocity may be repaired by priority, or a pipe having a shorter time before a deterioration level exceeds a predetermined threshold as a result of a prediction may be repaired by priority, for example.

The device in the present example may further include an output unit. The output unit outputs at least one of lists indicating the temporal change of the deterioration level and the repair order of the pipes 1a, 1b, . . . , and 1n. For example, the output unit includes a display, a printer, and the like. Moreover, the repair order can be not only visually output, but also output by sound, vibration, and the like, for example.

The device in the present example may further include a notification unit. For example, the notification unit notifies a repairer/replacer or the like of a pipe in which the deterioration level is equal to or more than a predetermined value. A means conventionally known in public may be used as the notification unit. Note that the notification unit may notify a party different from a repairer/replacer of a pipe or the like in which the deterioration level is equal to or more than a predetermined value.

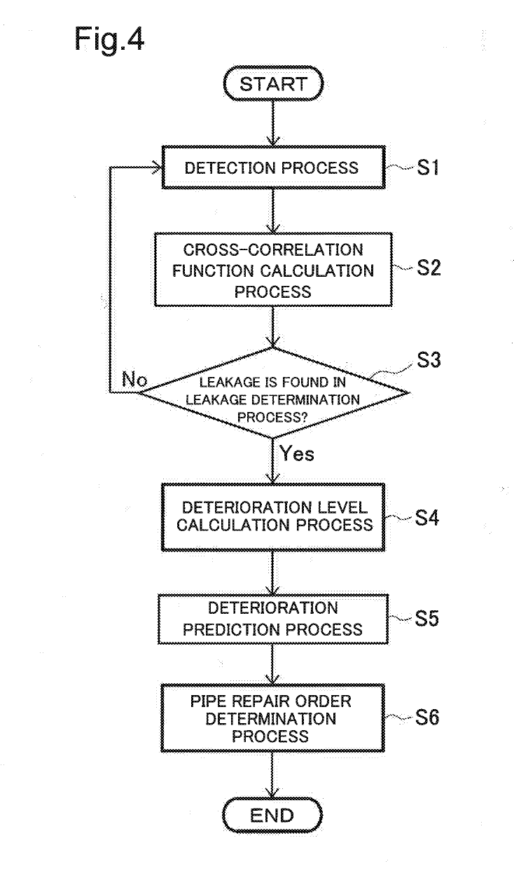

Next, the method according to the present example embodiment is described with reference to FIG. 4. For example, the method according to the present example embodiment can be realized by use of the device according to the present example embodiment illustrated in FIGS. 1 to 3.

FIG. 4 is a flowchart illustrating one example of the method according to the present example embodiment. First, in the method according to the present example embodiment, the N sets of (2N pieces) detection units 10 disposed in the pipes 1a, 1b, . . . , and 1n detect undulations of the pipes 1a, 1b, . . . , and 1n (step S1). The detected undulations are transmitted to the processing unit 20 by the transmitter 12 of the detection unit 10, and received by the receiver 21 of the processing unit 20.

Then, the cross-correlation function calculation unit 22 calculates N cross-correlation functions, based on the undulations of the N sets of (2N pieces) pipes 1 (step S2).

Then, the leakage determination unit 23 determines whether leakage is present with respect to each of the N cross-correlation functions (step S3). When the leakage determination unit 23 determines that leakage is present (Yes), the processing proceeds to step S4. On the other hand, when the leakage determination unit 23 determines that leakage is not present in all of the N pipes (No), the processing returns to step S1, a similar processing is repeated, and monitoring is continued to find whether or not leakage has occurred.

Then, the deterioration level calculation unit 24 calculates a deterioration level of a pipe determined to have leakage among the N pipes, based on a shape of the cross-correlation function of the pipe. As illustrated in FIG. 5, when damping coefficients of the pipes are different, shapes of the cross-correlation functions, particularly, half-value widths of maximum values of envelopes differ. Therefore, it is possible to obtain a damping coefficient of a pipe, based on a shape of a cross-correlation function. Specifically, it is possible to obtain a damping coefficient by fitting a cross-correlation function using an undulation propagating model to an actually measured cross-correlation function, or obtain a damping coefficient by use of a half-value width of a maximum value of an envelope of an actually measured cross-correlation function, for example. Note that in the example illustrated in FIG. 5, a half-value width of a maximum value of an envelope indicates width of an arrival time difference which is a half value of a maximum value of a cross-correlation function represented by an envelope. In addition, Kurikuma, Makimura, Tada, and Kobayashi, “Effects of Graphite Morphology and Matrix Microstructure on Damping Capacity, Tensile Strength and Young's Molulus of Casting Irons”, Japan Foundry Engineering Society, vol. 68, No. 10, pp 876 to 882, (1996) indicate that a damping coefficient changes due to a change of a pipe material characteristic resulting from deterioration or the like. Therefore, as described above, a deterioration level can be known based on a damping coefficient, for example. When the device includes the output unit, the output unit may output a temporal change of the deterioration level in the present process. Moreover, when the device includes the notification unit, the notification unit may notify, for example, a pipe repairer or the like of a pipe in which the deterioration level is equal to or more than a predetermined value, in the present process. In this case, the notification unit may notify a party different from a pipe repairer.

Then, the deterioration prediction unit 25 predicts a deterioration tendency of the pipe, based on a temporal change of the deterioration level. According to the present example embodiment, a deterioration tendency of a pipe can be accurately predicted by use of a deterioration level of a pipe.

Then, the pipe repair order determination unit 26 determines a repair order of the pipes 1a, 1b, . . . , and 1n, based on the deterioration tendency predicted by the deterioration prediction unit 25. When the device includes the output unit, the output unit may output a list indicating a repair order of the pipes 1a, 1b, . . . , and 1n in the present process. In the list, the pipes 1a, 1b, . . . , and 1n are arranged in an order of necessity of repair, and grouped at the same time, for example. For example, in the grouping, the pipes 1a, 1b, . . . , and 1n are classified into six groups including A: repair urgently, B: repair within one month, C: repair within one year, D: repair within three years, E: repair within ten years, and F: no need for repair for ten years or more. Moreover, repair time prediction information may be further indicated in the list. For example, the repair time prediction information includes prediction information that the pipe 1a will need repair due to leakage within one month or the like. Further, a pipe having a little temporal change of a deterioration level may be automatically removed from the list. Still further, a user may be able to remove a particular pipe from the list, or add a particular pipe to the list. For example, the user may remove a pipe which is known to be unused after one month from the list. When overall pipe repair work is conducted, the user may add the pipe to the list. According to the present example, it is possible to form a suitable repair schedule of a pipe by using a deterioration level of a pipe.

### Second Example Embodiment

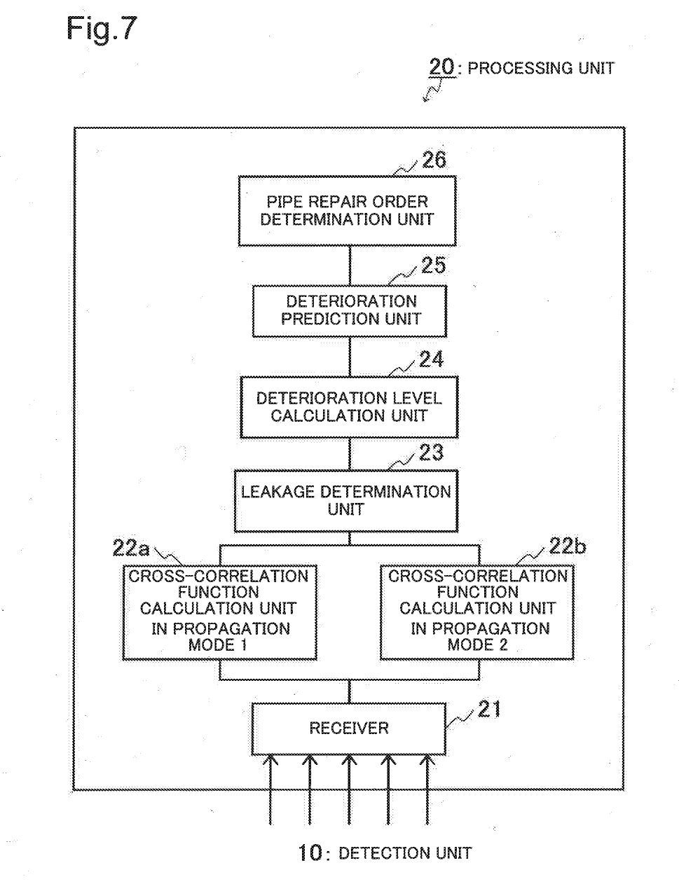

The present example embodiment is another example of the first device and the first method according to the present invention. One example of a configuration of a processing unit in a device according to the present example embodiment is illustrated in a schematic block diagram of FIG. 7. As illustrated, a processing unit 20 in the present example includes two cross-correlation function calculation unit. Apart from this, the device according to the present example embodiment is similar to the device according to the first example embodiment illustrated in FIGS. 1 to 3.

An undulation of a pipe is known to propagate in a plurality of different modes such as a torsional wave, a longitudinal wave, and a transverse wave. In the case described by way of example below in the present example embodiment, the torsional wave and the longitudinal wave that are two of the propagation modes are used.

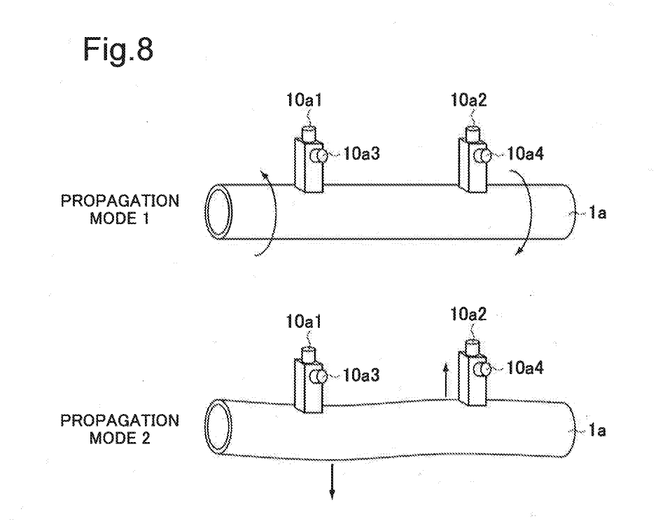

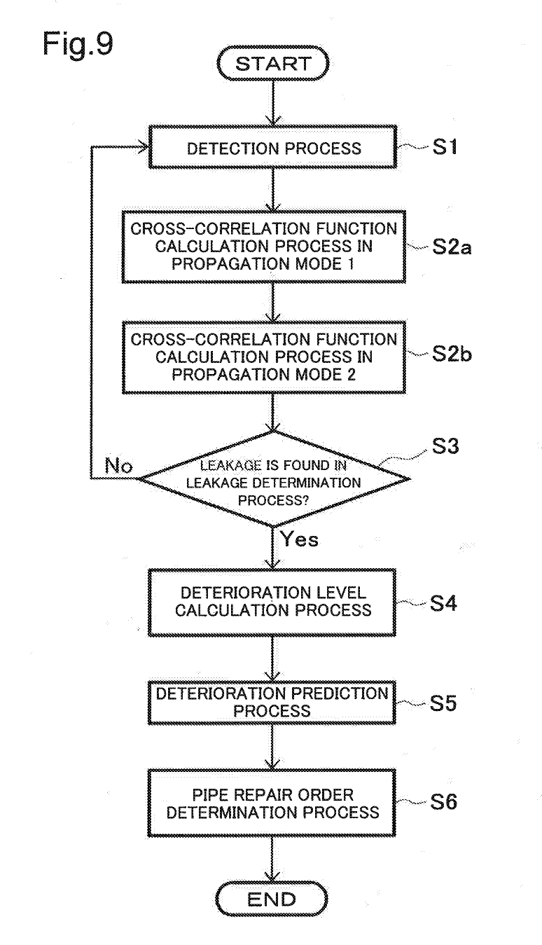

FIG. 9 is a flowchart illustrating one example of a method according to the present example embodiment. In the method according to the present example, the detection unit 10 first detects an undulation of the pipe 1 (step S1). In the present example, when the detection unit 10 is configured to detect vibration in a particular direction, it is possible to detect undulations of two propagation modes by disposing the detection unit 10 in the pipe 1 in a direction in which amplitude is maximized with respect to each of the two propagation modes as illustrated in FIG. 8, for example. For example, it is assumed that each of the detection units 10 detects vibration in an axial direction of a circular cylindrical figure indicating the detection unit 10a1 or the like in FIG. 8. In this case, the detection units 10a1, 10a2, 10b1, 10b2, . . . , 10n1, and 10n2 disposed in the pipes 1a, 1b, . . . , and 1n detect an undulation in a propagation mode 2, and detection units 10a3, 10a4, 10b3, 10b4, . . . , 10n3, and 10n4 detect an undulation in a propagation mode 1. The detected undulations are transmitted to the processing unit 20 by a transmitter 12 of the detection unit 10, and received by a receiver 21 of the processing unit 20.

Then, a cross-correlation function calculation unit 22a in the propagation mode 1 calculates N cross-correlation functions, based on the undulations in the propagation mode 1 detected by the N sets of (2N pieces) detection units 10a1, 10a2, 10b1, 10b2, . . . , 10n1, and 10n2 (step S2a).

Then, a cross-correlation function calculation unit 22b in the propagation mode 2 calculates N cross-correlation functions, based on the undulations in the propagation mode 2 detected by the N sets of (2N pieces) detection units 10a3, 10a4, 10b3, 10b4, . . . , 10n3, and 10n4 (step S2b).

Then, a leakage determination unit 23 determines whether leakage is present with respect to each of the N pipes (step S3). In this instance, one or both of the cross-correlation functions in the propagation mode 1 and the propagation mode 2 may be used with respect to one pipe.

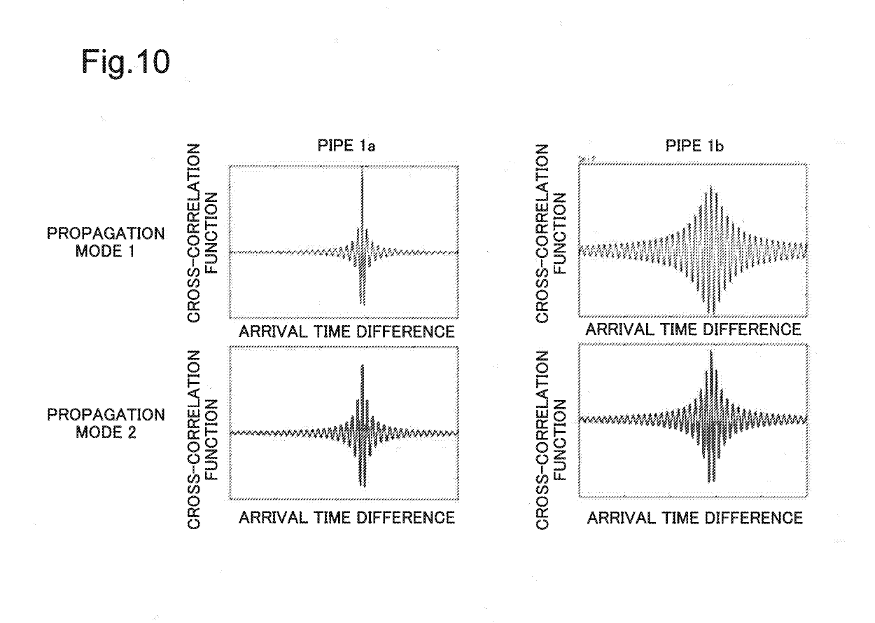

Then, a deterioration level calculation unit 24 calculates a up deterioration level, based on a shape of the cross-correlation function of the pipe determined to have leakage by the leakage determination unit 23 (step S4). FIG. 10 illustrates one example of a cross-correlation function in each propagation mode calculated for the pipe 1a and the pipe 1b. In the present example embodiment as well as in the first example embodiment, a damping coefficient may be calculated based on a shape of a cross-correlation function, and a deterioration level may be calculated by use of this damping coefficient.

Then, a deterioration prediction unit 25 predicts a deterioration tendency of the pipe, based on a temporal change of the deterioration level (step S5).

Then, a pipe repair order determination unit 26 determines a repair order of the pipes 1a, 1b, . . . , and 1n, based on the deterioration tendency predicted by the deterioration prediction unit 25 (step S6). For example, in the determination of the repair order, one of the predictions in the propagation mode 1 and the propagation mode 2 which is higher in deterioration velocity may be used, or a sum of deterioration curves which are each weighted may be used. For example, it is assumed that the propagation mode 1 reflects a state of the pipe in an axial direction, and the propagation mode 2 reflects a state of the pipe in a sectional direction. Then, it is possible to comprehensively express deterioration states in the both axial and sectional directions by properly weighting both of the deterioration curves and taking a sum.

According to the present example embodiment, it is possible to obtain advantageous effects similar to those in the first example embodiment, and it is also possible to accurately predict a deterioration tendency of a pipe, and form a more suitable repair schedule of a pipe, by calculating a deterioration level, based on shapes of cross-correlation functions in a plurality of propagation modes.

### Third Example Embodiment

The present example embodiment is still another example of the first device and the first method according to the present invention. A device according to the present example embodiment is the same as the device according to the first example embodiment illustrated in FIGS. 1 to 3, and a method according to the present example embodiment is the same as the method according to the first example embodiment except that a detection unit 10 detects undulations of a pipe 1 a plurality of times.

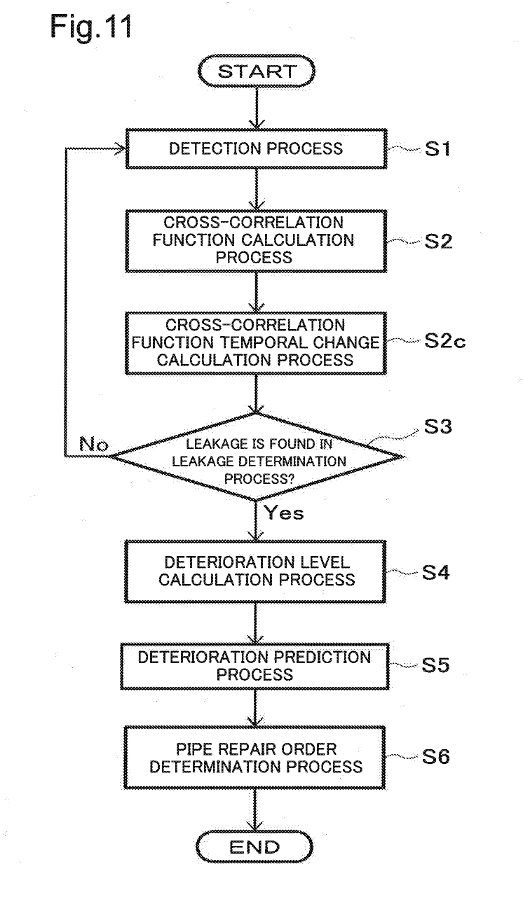

FIG. 11 is a flowchart illustrating one example of a method according to the present example embodiment. In the method according to the present example embodiment, N sets of (2N pieces) detection units 10 disposed in N pipes 1 first detect undulations a plurality of times while changing time zones of detection (step S1). The detected undulations are transmitted to a processing unit 20 by a transmitter 12 of the detection unit 10, and received by a receiver 21 of the processing unit 20.

Then, a cross-correlation function calculation unit 22 calculates N cross-correlation functions for the number of detection times, based on the aforementioned N sets of (2N pieces) undulations detected a plurality of times (step S2).

Then, the cross-correlation function calculation unit 22 calculates temporal changes of the N cross-correlation functions for the number of detection times (step S2c). Note that the present process may be carried out by use of a cross-correlation function temporal change calculation unit different from the cross-correlation function calculation unit 22.

Then, a leakage determination unit 23 determines whether leakage is present with respect to each of the N pipes (step S3). Specifically, the leakage determination unit 23 determines that leakage is present in a pipe in which a maximum value of the cross-correlation function is beyond a predetermined value and a temporal change is small, for example.

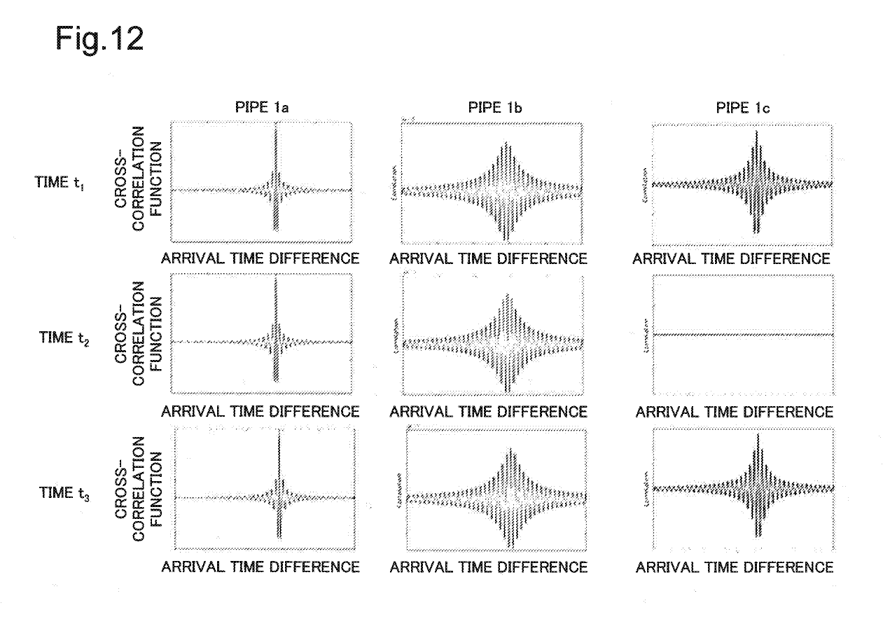

FIG. 12 illustrates an example of cross-correlation functions in three time zones calculated for the pipes 1a, 1b, and 1c. The cross-correlation functions of the pipes 1a and 1b have the same shapes in the three time zones, respectively. However, the cross-correlation functions of the pipe 1c have peaks in time zones t1 and t3, but does not indicate a peak in a time zone t2. In general, it is considered that an undulation of a pipe at leakage indicates a stationary behavior. Thus, in the present example, the pipes 1a and 1b are determined to have leakage, and the pipe 1c is determined to have no leakage.

The rest is similar to that in the method according to the first example embodiment.

According to the present example embodiment, it is possible to obtain advantageous effects similar to those in the first example embodiment, and it is also possible to accurately predict a deterioration tendency of a pipe, and form a more suitable repair schedule of a pipe, by calculating a temporal change of a cross-correlation function and removing unsteady disturbance.

### Fourth Example Embodiment

The present example embodiment is one example of a second device and a second method according to the present invention. A device according to the present example embodiment includes a plurality of detectors, a deterioration level calculation unit, and a pipe repair order determination unit. The plurality of detectors are the same as those in the device according to the first example embodiment. The device according to the present example embodiment may further include the cross-correlation function calculation unit, the deterioration prediction unit, the leakage determination unit, the output unit, and the notification unit in the device according to the first example embodiment.

The deterioration level calculation unit calculates a deterioration velocity which is a temporal change of a deterioration level of the pipe, up based on undulations at least two locations in the pipe detected by the plurality of detectors. When the device according to the present example embodiment includes the cross-correlation function calculation unit, the deterioration level may be calculated as in the first example embodiment. Moreover, the deterioration level may be calculated by ultrasonic pipe thickness measurement, endoscopic pipe inner surface observation, eddy-current surface crack search, or the like, for example. By way of example, when the surface crack search is used, a ratio between the number of measured surface cracks and an average value of the numbers of surface cracks in a deteriorated pipe is calculated as a deterioration level. The average value of the numbers of surface cracks in the deteriorated pipe is previously obtained and then previously saved in a database or the like, for example. The deterioration velocity can be calculated from a graph or the like illustrated in FIG. 6, for example.

The pipe repair order determination unit determines a repair order of the plurality of pipes, based on the deterioration velocity of each of the pipes. Specifically, a pipe higher in deterioration velocity is repaired by priority, for example. In the determination of the repair order of the plurality of pipes, it is possible to use, in addition to the deterioration velocity of each of the pipes, other information such as pipe physical property information including a deterioration level, a corrosion level, a fatigue level, a corrosion velocity, a fatigue velocity, presence of leakage, a leakage amount, a leakage rate, and the like; pipe attribute information including a use start time, the number of years of use, thickness, length, an aperture, wall thickness, whether or not to be close to a branch position, whether or not to be connected to a joint, history of past leakage, history of past bursting accidents, and the like; pipe surrounding environment information including a temperature change, a surrounding building, soil information of a burial place, a road on a burial place, a surrounding railroad, and the like; presence of a water hammer phenomenon; and the like in a fifth example embodiment described later.

According to the present example embodiment, it is possible to form a more suitable replacement schedule of a pipe by adopting a deterioration velocity.

### Fifth Example Embodiment

The present example embodiment is one example of a third device and a third method according to the present invention. A device according to the present example embodiment includes a pipe information acquisition unit, a repair order list generation unit, and a list output unit.

The pipe information acquisition unit acquires information about each of a plurality of linked pipes. For example, the information about each of the plurality of linked pipes includes pipe physical property information, pipe attribute information, pipe surrounding environment information, other information, and the like.

As examples of the pipe physical property information, a deterioration level, a corrosion level, a fatigue level, a deterioration velocity, a corrosion velocity, a fatigue velocity, presence of leakage (a pipe having leakage is repaired by priority), a leakage amount (a pipe having a greater leakage amount is repaired by priority), a leakage rate, and the like can be mentioned.

As examples of the pipe attribute information, a use start time, the number of years of use, thickness, length, an aperture (a pipe having a larger aperture is repaired by priority), wall thickness, a material, whether or not to be close to a branch position, whether or not to be connected to a joint, histories of past leakage and bursting accidents, and the like can be mentioned.

As examples of the pipe surrounding environment information, a temperature change, a surrounding building (e.g., a hospital or a publicly important facility in which a pipe should be repaired by priority is present near or within a predetermined range, and the like), soil information of a burial place (e.g., pH, salt content, specific resistance, breathability, and the like), a road (e.g., significant deterioration in the case of an expressway or an industrial road, and the like) on a burial place, a surrounding railroad (e.g., a railroad on which a train passes is quickly corroded because an electric current passes in the ground under the railroad, and the like), and the like can be mentioned.

As examples of the other information, presence of a water hammer phenomenon (deterioration is quick with the presence of a water hammer phenomenon), and the like can be mentioned.

The repair order list generation unit determines a repair order of the plurality of pipes, and generates a list of a pipe repair order, based on the information about each of the pipes. The list may be generated based on one of pieces of information about each of the pipes, or information in which pieces of information about the plurality of respective pipes are combined. The pipe repair order in the list is variable based on the information about each of the plurality of respective pipes. For example, a generating procedure of the list is exemplified as follows. The list is generated based on a deterioration velocity or the like, except when an earthquake occurs, for example. When an earthquake occurs, there is a high possibility that leakage, deterioration, and the like are caused at a plurality of places, and therefore, the list is generated based on a surrounding building and the like. For example, when a stadium or the like where an event using a large amount of water is taking place is present, the list is generated based on a leakage amount, a leakage rate, an aperture, and the like. However, the generating procedure of the list is only an example, and does not limit the present invention. The list is similar to the list in the first example embodiment, and a plurality of pipes are arranged in an order of necessity of repair, and grouped at the same time, for example. For example, in the grouping, the respective pipes are classified into six groups including A: repair urgently, B: repair within one month, C: repair within one year, D: repair within three years, E: repair within ten years, and F: no need for repair for ten years or more. Moreover, repair time prediction information may be further indicated in the list. For example, the repair time prediction information includes prediction information that the pipe will need repair due to leakage within one month, or the like. Further, a pipe having a little temporal change of a deterioration level may be automatically removed from the list. Still further, a user may be able to remove a particular pipe from the list, or add a particular pipe to the list. For example, the user may remove a pipe which is known to be unused after one month from the list. When overall pipe repair work is conducted, the user may add the pipe to the list.

The list output unit outputs the list of the pipe repair order. The list output unit is similar to the list output unit in the first example embodiment, and includes a display, a printer, and the like, for example. Moreover, the repair order can be not only visually output, but also output by sound, vibration, and the like.

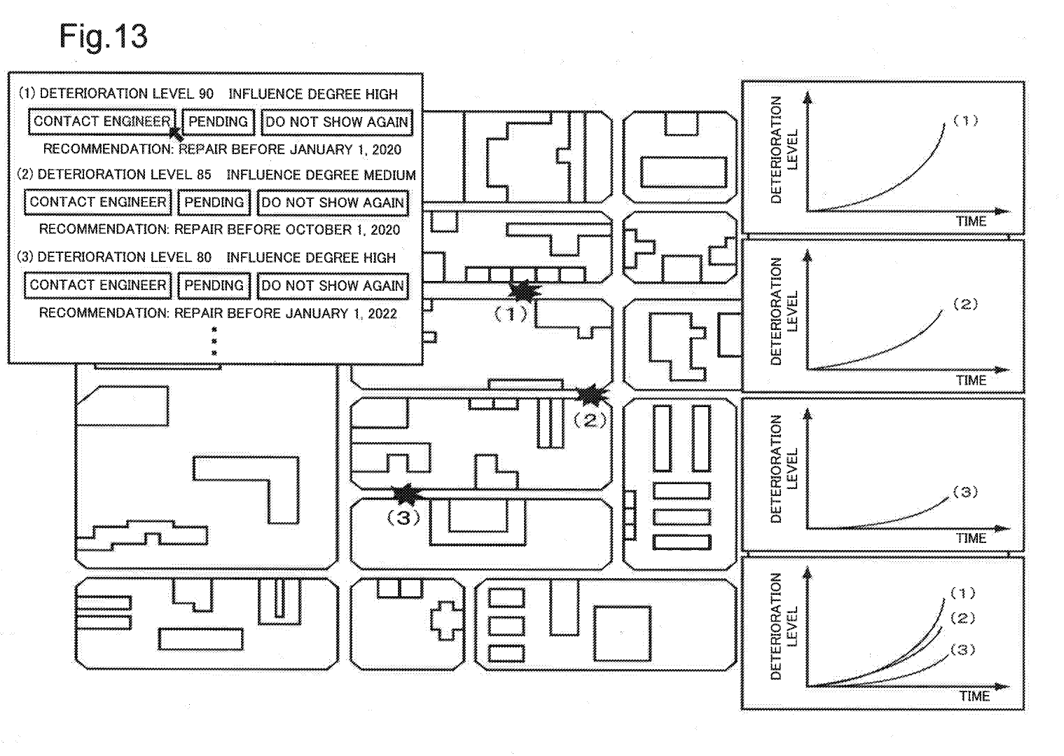

An output example in the present example embodiment is described with reference to FIG. 13. Output in the example illustrated in FIG. 13 are a list (upper left in this drawing) of the pipe repair order, a map indicating mounting locations of the pipes arranged in the order of necessity of repair in the list, and graphs (right side of this drawing) indicating the deterioration velocities of the pipes. In the list on the upper left of this drawing, (1), (2), and (3) are in the order of necessity of repair. Further output together in the list are a calculated value of a deterioration level of each pipe, whether an influence degree of deterioration (e.g., an important facility is present near or within a predetermined range, or the like) is high or low, and a recommended time of repair. Moreover, three kinds of buttons selected by the user are also output together in the list. When the user selects “contact engineer” among the three kinds of buttons by clicking with a mouse cursor or the like, a request for repair is communicated to a pipe repairer. Similarly, when the user selects “pending”, the pipe is again indicated on the list at a time of next update or when a deterioration velocity changes to a predetermined value or more before a time of update, for example. When the user selects “do not show again”, the pipe is not indicated any more on the list except when a deterioration velocity changes to a predetermined value or more before a time of update. On the right side of this drawing, a graph indicating a relation between time and a deterioration level for each pipe is output, in such a way that the user can recognize a deterioration velocity of each pipe. On the lower right of this drawing, a graph in which up three graphs thereabove are combined into one is output, in such a way that the user can easily compare deterioration velocities of the respective pipes. In the present example, thresholds of a deterioration level, a deterioration velocity, and the like may be output together. In addition, the user can freely select whether or not to output a deterioration level, an influence degree, a deterioration velocity, and the like. Note that FIG. 13 illustrates one example of output, and the present example embodiment is not limited thereto.

According to the present example embodiment, it is possible to form and output a suitable repair schedule of a pipe.

Example embodiments 1 to 5 can be combined without departing from a technical concept of the present invention.

### Sixth Example Embodiment

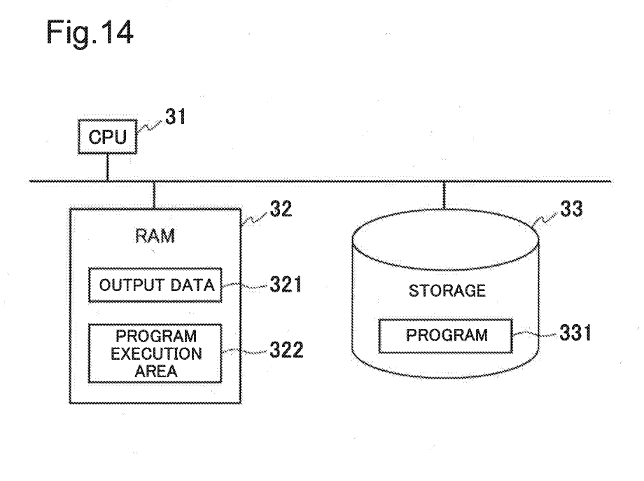

A program according to the present example embodiment is a program which enables the method described above to be executed by a computer. The program according to the present example embodiment may be recorded in a recording medium, for example. The recording medium is not particularly limited, and includes a random access memory (RAM), a read only memory (ROM), a hard disk (HD), an optical disk, a floppy (registered trademark) disk (FD), and the like, for example. One example of a hardware configuration of a device which realizes the program according to the present example embodiment is illustrated in a schematic block diagram of FIG. 14. As illustrated, the device in the present example includes a CPU (central processing unit) 31, a RAM 32, and a storage 33. The CPU 31 is a processor for arithmetic operation control, and executes the program according to the present example embodiment. The RAM 32 is a temporary storage unit used by the CPU 31 as a work area for temporary storage, and output data 321 is temporarily stored in the RAM 32. Further, the RAM 32 includes a program execution area for executing the program according to the present example embodiment. The storage 33 stores a program 331 according to the present example embodiment in a nonvolatile manner. Note that FIG. 14 illustrates one example of a hardware configuration, and a device which realizes the program according to the present example embodiment is not limited thereto.

While the present invention has been described above with reference to the example embodiments, the present invention is not limited to the example embodiments described above. Various modifications that can be understood by a person skilled in the art can be made to the configuration and details of the present invention within the scope of the present invention.

This application is based upon and claims the benefit of priority from Japanese patent application No. 2015-236985, filed on Dec. 3, 2015, the disclosure of which is incorporated herein in its entirety by reference.

### INDUSTRIAL APPLICABILITY

According to the present invention, it is possible to provide a device and a method which enable a deterioration tendency of a pipe to be accurately predicted. The device and the method according to the present invention are widely applicable to various pipes including a pipe that constitutes piping networks for transporting water, petroleum, gas, and the like.

### REFERENCE SIGNS LIST

1 Pipe
2 Leakage hole
10 Detection unit
11 Sensor
12 Transmitter
20 Processing unit
21 Receiver
22 Cross-correlation function calculation unit
23 Leakage determination unit
24 Deterioration level calculation unit
25 Deterioration prediction unit
26 Pipe repair order determination unit

What is claimed is:

1. A device comprising:
a plurality of detectors and at least one processor, the processor implementing a cross-correlation function calculation unit, a deterioration level calculation unit, and a deterioration prediction unit, wherein
the plurality of detectors detect undulations at least two locations in a pipe in which fluid flows,
the cross-correlation function calculation unit calculates a cross-correlation function of the pipe, based on undulations at least two locations in the pipe which are detected by the plurality of detectors,
the deterioration level calculation unit calculates a deterioration level of the pipe, based on a shape of a cross-correlation function of the pipe, and
the deterioration prediction unit predicts a deterioration tendency of the pipe, based on a temporal change of the deterioration level.

2. The device according to claim 1, further comprising a leakage determination unit, wherein
the leakage determination unit determines whether or not leakage is present in the pipe, based on a cross-correlation function of the pipe.

3. The device according to claim 1, wherein
the pipe is each of a plurality of linked pipes,
the device further comprises a pipe repair order determination unit, and
the pipe repair order determination unit determines a repair order of the plurality of pipes, based on a deterioration tendency predicted by the deterioration prediction unit.

4. The device according to claim 1, wherein
the deterioration level calculation unit calculates the deterioration level, based on a damping coefficient of the pipe obtained from a shape of a cross-correlation function of the pipe.

5. The device according to claim 4, wherein
the deterioration level calculation unit calculates the damping coefficient, based on a half-value width of an envelope of a cross-correlation function of the pipe.

6. The device according to claim 1, wherein
the deterioration level calculation unit calculates the deterioration level, based on shapes of cross-correlation functions in a plurality of propagation modes of the pipe.

7. The device according to claim 6, wherein
the deterioration level calculation unit calculates cross-correlation functions in a plurality of propagation modes of the pipe by changing mounting directions of the plurality of detectors in the pipe.

8. The device according to claim 2, wherein
the leakage determination unit determines whether or not leakage is present in the pipe, based on a temporal change of a cross-correlation function of the pipe.

9. (canceled)

10. (canceled)

11. (canceled)

12. (canceled)

13. (canceled)

14. (canceled)

15. (canceled)

16. The device according to claim 1, further comprising a notification unit, wherein
the notification unit notifies a pipe repairer of a pipe in which the deterioration level is equal to or more than a predetermined value.

17. (canceled)

18. (canceled)

19. (canceled)

20. (canceled)

21. (canceled)

22. (canceled)

23. (canceled)

24. A method executed by at least one processor comprising:
detecting, by use of a plurality of detectors disposed in a pipe in which fluid flows, undulations at least two locations in the pipe;
calculating a cross-correlation function of the pipe, based on undulations at least two locations in the pipe which are detected by the plurality of detectors;
calculating a deterioration level of the pipe, based on a shape of the cross-correlation function of the pipe, and
predicting a deterioration tendency of the pipe, based on a temporal change of the deterioration level.

25. The method according to claim 24, further comprising:
determining whether or not leakage is present in the pipe, based on a cross-correlation function of the pipe; and,
when calculating the deterioration level, calculating a deterioration level of the pipe, based on a shape of the cross-correlation function of a pipe determined to have leakage in the determination of leakage.

26. The method according to claim 24, wherein
the pipe is each of a plurality of linked pipes, and
the method further comprises determining a repair order of the plurality of pipes, based on the deterioration tendency.

27. (canceled)

28. (canceled)

29. A computer-readable non-transitory recording medium in which a program is stored, the program causing a computer to execute:
processing of detecting, by use of a plurality of detectors disposed in a pipe in which fluid flows, undulations at least two locations in the pipe;
processing of calculating a cross-correlation function of the pipe, based on undulations at least two locations in the pipe which are detected by the plurality of detectors; and
processing of calculating a deterioration level of the pipe, based on a shape of the cross-correlation function of the pipe, and predicting a deterioration tendency of the pipe, based on a temporal change of the deterioration level.

30. The computer-readable recording medium according to claim 29, wherein the program further causes to execute:
processing of determining whether or not leakage is present in the pipe, based on a cross-correlation function of the pipe; and
processing of, when calculating the deterioration level, calculating a deterioration level of the pipe, based on a shape of the cross-correlation function of a pipe determined to have leakage in the determination of leakage.

31. The computer-readable recording medium according to claim 29, wherein
the pipe is each of a plurality of linked pipes, and
the program further causes to execute processing of determining a repair order of the plurality of pipes, based on the deterioration tendency.

32. (canceled)

33. (canceled)
